(19) United States
(12) Patent Application Publication
(10) Pub. No.: US 2017/0290353 A1
(43) Pub. Date: Oct. 12, 2017

(54) SYSTEM AND METHOD FOR PROCESSING COFFEE BEANS

(71) Applicant: Edgar E. Salgado, Miami Lakes, FL (US)

(72) Inventor: Edgar E. Salgado, Miami Lakes, FL (US)

(21) Appl. No.: 15/094,114

(22) Filed: Apr. 8, 2016

(51) Int. Cl. A23F 5/02

(52) U.S. Cl. CPC A23F 5/02

(57) ABSTRACT

A method for the intermediate processing of coffee beans, utilizing natural thermal mineral spring water, where in the beans have reached a parchment stage of production. The coffee beans with the mucilage layer are delivered to a resting facility concurrently to the combining of the thermal spring water therewith. The thermal spring water having an at least minimal predetermined temperature is added to the resting facility in sufficient quantities to maintain the coffee beans with the mucilage layer in a submerged state for a predetermined time, resulting in a removal of the mucilage layer from the coffee beans. The thermal spring water is subsequently drained from the resting facility and the coffee beans, upon conclusion of the predetermined time for resting. After removing the drained coffee beans from the resting facility the coffee beans are delivered to additional processing facilities.

### BACKGROUND OF THE INVENTION

### Field of the Invention

The present invention is directed to a system and method for processing coffee beans which includes an intermediate processing step primarily directed to the fermentation of coffee beans once having reached a parchment stage. The unique fermentation process includes the utilization of thermal mineral spring water, wherein the coffee beans with a mucilage layer are delivered to a resting tank or like facility and submerged in the natural mineral thermal spring water or thermal mineral spring water initially having a predetermined temperature. The coffee beans with a mucilage layer are maintained in the submerged condition for a predetermined, reduced, period of time concurrently to the gradual cooling of the thermal mineral spring water.

### Description of the Related Art

Coffee production is the industrial process, wherein the raw fruit of the coffee plant is processed into the finished coffee product ready for consumption. The cherry of the coffee plant has the fruit or pulp removed leaving the seed or bean which is then dried. While all green coffee is processed, the method that is used varies and can have a significant effect on the flavor of roasted and brewed coffee. Coffee production is a major source of income, especially for developing countries where coffee is grown. By adding value, processing the coffee locally, coffee farmers and countries can increase the revenue from coffee.

A coffee plant usually starts to produce flowers 3 to 4 years after being planted. It is from these flowers that the fruits of the plant, commonly known as coffee cherries, appear with the first useful harvest possibly around five years after planting. The cherries ripen around eight months after the emergence of the flower. By changing the color from green to red an indication is provided that it is time for harvesting. Only ripe cherries are harvested and they are commonly picked individually by hand.

As an intermediate part of the overall method for processing coffee from the time of harvest to the time of consumption, a fermentation process is performed and monitored to ensure that the coffee doesn't acquire undesirable, sour flavors. In a typical “dry fermentation” process, mucilage is removed and takes between 24 and 36 hours, depending on the temperature, thickness of the mucilage layer and concentration of the enzymes. Also in typical fashion, the end of the fermentation is assessed by “feel”, as the parchment surrounding the beans loses a slimy texture and acquires a rougher “pebbly” feel. When the fermentation is complete, the coffee is thoroughly washed.

The removal of mucilage from the coffee bean may be done by mechanical means. However, by eliminating the fermentation step and prematurely separating the fruit and bean, mechanical demucilaging can remove an important tool that mill operators have to influence the coffee flavor.

After the pulp has been removed from the bean, it contains other/more additional layers including the mucilage and the parchment. The beans must be dried to a water content of generally about 10% before they are stable. Coffee beans can be dried in the sun or by machine to a predetermined moisture level.

Absent from conventional or known methods, systems and procedures for the processing of the coffee beans is an effective fermentation process and/or procedure which significantly reduces the fermentation or resting time. As noted, conventional dry fermentation methods normally take between 18 and 36 hours. Accordingly, a more effective fermentation procedure or process for the treatment of coffee beans would be beneficial to the entire industry. Further, such a preferred procedure would be directly associated with the fermentation of coffee beans which have reached a parchment stage. Moreover, a preferred and proposed fermentation procedure and attendant system may involve the use of water having a “predetermined content”, being applied to the coffee beans in a predetermined manner at a predetermined temperature or temperature range. Moreover, a preferred “water content” would preferably comprise natural thermal spring water or thermal mineral spring water, which includes a perfect mix of minerals that have a natural balance. The use of the predetermined or preferred “water content” in the form of natural thermal spring water or thermal mineral spring water, serves to enhance the overall characteristics of the coffee bean and is most prevalent at time of consumption of the final product.

### SUMMARY OF THE INVENTION

The present invention is directed to a system and method for processing coffee beans which includes an intermediate processing step primarily directed to the fermentation of coffee beans with a mucilage layer. The unique fermentation process includes the utilization of thermal spring water. Moreover, as used herein the term “thermal spring water” is meant to include natural thermal spring water or thermal mineral spring water and the equivalent thereof. Accordingly, the coffee beans with the mucilage layer are delivered to a resting tank or like facility and submerged in the “thermal spring water” defined as the aforementioned natural mineral thermal spring water or thermal mineral spring water, which has an initial predetermined temperature. The coffee beans with the mucilage layer are maintained in the submerged condition for a predetermined, relatively short period of time concurrently with the gradual cooling of the natural mineral thermal spring water or thermal mineral spring water.

It is of further note that the use of natural mineral thermal spring water or thermal mineral spring water in the fermentation procedure (natural enzymatic fermentation) of the coffee beans accelerates the dissolution of the mucilage and emphasizes the characteristics and aroma of the coffee. As a result of this intermediate procedure or process in the overall method of processing coffee beans produces a much cleaner coffee bean and an enriched beverage at the consumption stage.

The intermediate wet fermentation processing procedure in natural thermal mineral spring water is considered unique and distinguishable from known coffee bean processing techniques, which typically use a dry resting or dry fermentation procedure. Disadvantages associated therewith, as generally set forth above, include an extended resting period of time being generally about 18 to 24 hours. Distinguishing features of the included wet fermentation processing procedure include the use of natural mineral thermal spring water applied to the coffee beans with the mucilage, depending upon the stage, at different predetermined temperatures. Accordingly, as generally referred to herein the term “predetermined water content” is meant to include the use of natural mineral thermal spring water or thermal mineral spring water, wherein the water is found to be extremely clean containing natural minerals, a natural balance and generally considered not volcanic. In contrast, the utilization of commonly available, publicly treated water, not derived from natural spring sources is difficult to implement in the fermentation/resting process as set forth hereinafter. Further, the utilization of common water content, as versus “predetermined water content” comprising natural thermal spring water or thermal mineral spring water, is found to be costly and lacks the minerals, balance, etc. that is believed to give the processed coffee beans with the mucilage layer desirable coffee characteristics, including enhanced aroma and taste when consumed.

The present invention further includes the possible use of the rewarming, heating or the temperature adjustment of natural mineral thermal spring water or thermal mineral spring water, which has been stored, in a manner which does not alter the mineral content, balance, etc. The use of reheated natural mineral thermal spring water or thermal mineral spring water from a stored reservoir or supply has been found to be acceptable in the intermediate wet processing fermentation procedure. Accordingly, the term “predetermined water content” is meant to include natural mineral thermal spring water or thermal mineral spring water which has been properly stored and possibly treated to achieve a preferred temperature and/or temperature range, as also set forth herein.

Accordingly, in the wet fermentation processing step, the coffee beans with the mucilage layer (mesocarp and endocarp) reach resting tanks or like facilities. In at least one embodiment of the present invention the resting facilities are filled with the coffee beans with the mucilage layer concurrent with the filling and simultaneous draining of water there through. When the coffee beans with the mucilage layer fills the resting tanks or facilities to a predetermined capacity, preferably a maximum capacity, draining ceases. Thereafter, the referred to natural mineral spring thermal water or thermal mineral spring water is added to each resting tank or facility in sufficient quantities to cover in a submerged state, all of the coffee beans contained in the corresponding resting tank or facility.

In one or more additional preferred embodiments, the present invention also contemplates either first filling the resting tanks with natural mineral thermal spring water or thermal mineral spring water and then adding/filling the resting tanks with the coffee beans with the mucilage or alternatively first filling the resting tanks with the coffee beans with the mucilage and then filling the resting tanks with the natural mineral thermal spring water or thermal mineral spring water, in sufficient quantities to submerged the coffee beans with mucilage. However, in each instance the temperature of the natural mineral thermal spring water or thermal mineral spring water is controlled, as set forth in greater detail herein. Accordingly and as also indicated above, at least one unique feature of the system and method of the present invention comprises the effective “disappearance” of mucilage after the resting period, resulting in extremely clean coffee bean.

More specifically, the coffee beans with the mucilage layer are left to rest in a submerged state within the natural mineral thermal spring water or thermal mineral spring water for a minimum of eight hours and preferably for a resting time of 8 to 12 hours. As set forth above, this is a significantly less resting time than presently required in a dry resting/fermentation procedure commonly known. Further, when obtain from its natural source, the natural mineral thermal spring water or thermal mineral spring water is considered to be within the hyperthermal range, generally at 149° F. to 158° F. However, before submerging the coffee beans with the mucilage layer in the natural mineral thermal spring water or thermal mineral spring water, the temperature thereof is allowed to drop to a preferred temperature range of 113° F. As such, the natural mineral thermal spring water or thermal mineral spring water is allowed to cool from the hyperthermal temperature range, as set forth above, to a mesothermal temperature range of about 113° F.

In addition, during the resting time of between 8 to 12 hours the spring thermal water is allowed to gradually and naturally cool to what may be considered a hypothermal temperature range, being cooler than the initial 113° F. Moreover, the addition of thermal water within the predetermined temperature ranges results in an enhancement of the enzymatic process of the mesocarp or mucilage, which in turn results in obtaining the coffee beans without the mucilage layer in an extremely clean condition wherein all pollutants and objectionable flavor causing ingredients are removed. Upon conclusion of the resting period of from 8 to 12 hours, the coffee beans without the mucilage layer are removed from the resting facility and processing thereof is continued.

Accordingly and as also indicated above, at least one feature of the system and method of the present invention comprises the effective “disappearance” of mucilage after the resting period, resulting in extremely clean coffee bean.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation in block diagram form of the system and method of the present invention.

Like reference numerals refer to like parts throughout the several views of the drawings.

### DETAILED DESCRIPTION OF THE PREFERRED EMBODIMENT

The present invention, as schematically represented in the accompanying FIGURE is directed to a system and method, generally indicated as 100 which includes an intermediate fermentation processing procedure and/or series of steps primarily directed to the wet fermentation of coffee beans with a mucilage layer.

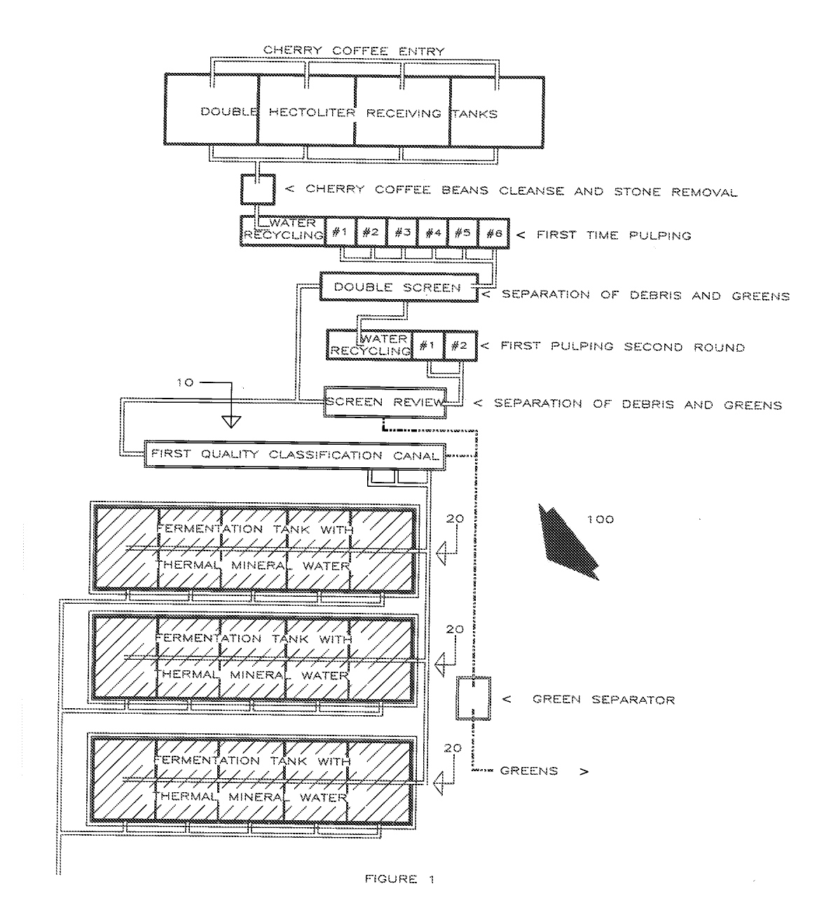

As also schematically represented in FIG. 1, the overall processing of coffee beans with the mucilage layer, in accord with the present invention, includes an intermediate fermentation process and/or method, which may be performed subsequent to or “intermediately” after coffee beans have been processed in accord with known or conventional steps and/or procedures, as schematically represented.

As represented in FIG. 1, the intermediate of natural mineral thermal water in the wet fermentation processing procedure, generally indicated as 100, is considered unique and distinguishable from known coffee bean processing techniques, which typically use a dry resting or dry fermentation procedure. Disadvantages associated therewith, as generally set forth above, include an extended resting period of time being generally about 24 hours. Distinguishing features of the included wet fermentation processing procedure include the use of natural mineral thermal spring water or thermal mineral spring water applied to the coffee beans with a mucilage layer, depending upon the stage, at different predetermined temperatures. Accordingly, as generally referred to herein the term “predetermined water content” is meant to include the term “thermal spring water” which in turn is meant to include natural thermal spring water or thermal mineral spring water and the equivalent thereof. the use of natural mineral thermal spring water or thermal mineral spring water, wherein the water is extremely clean containing natural minerals in natural balance and generally considered not volcanic. In contrast, the utilization of commonly available, publicly treated or purified water, not derived from natural spring sources, is difficult to implement in the fermentation/resting process as set forth hereinafter, at least to the extent of accomplishing the desired characteristics of the fermented beans. Further, the utilization of common water content, as versus predetermined water content comprising natural mineral thermal spring water or thermal mineral spring water, is found to be costly and lacks the minerals, balance, etc. that is believed to give the processed coffee beans with mucilage layer desirable coffee characteristics, including enhanced aroma and taste during the final stage of consumption.

The present invention further includes the rewarming, heating or temperature adjustment of natural mineral thermal spring water or thermal mineral spring water, which has been stored, in a manner which does not alter the mineral content, balance, etc. The use of reheated or temperature treated natural mineral thermal spring water or thermal mineral spring water from an appropriate stored reservoir or supply has been found to be acceptable in the intermediate wet processing fermentation procedure. Accordingly, the term “predetermined water content” is meant to include natural mineral thermal spring water or thermal mineral spring water, which has been properly stored, as set forth above.

Subsequent to an initial processing of the coffee beans with mucilage, which may include a first pulping procedure, the coffee beans with mucilage are transported in canals or channels, as schematically and generally represented as 10 in FIG. 1, to resting facilities or tanks 20. This may be accomplished by transporting the coffee beans with mucilage in canals or channels 10 with regular water or in the alternative in channels 10 without water. If the delivery channels 10 include the use of regular water to accomplish transport to the resting facilities or tank 20, the regular water is drained from the resting tanks 20 and the resting tanks are then refill with the mineral thermal water or thermal mineral spring water, as set forth in greater detail hereinafter.

Accordingly, in the wet fermentation processing step, generally indicated as 20, the coffee beans covered by the mesocarp and the endocarp reaches the schematically represented resting tanks or like facilities. In at least one embodiment, The resting facilities are filled with the coffee beans with the mucilage layer, concurrent with the filling and simultaneous draining of water there through. When the coffee beans with the mucilage layer fills the resting tanks or facilities to a predetermined capacity, preferably a maximum capacity, the drain valves or like devices are closed. Thereafter, the referred to natural mineral thermal spring water or thermal mineral spring water is added to each resting tank or facility in sufficient quantities to cover in a submerged state all of the coffee beans with the mucilage layer contained in the corresponding resting tank or facility.

However and as a viable alternative, one or more additional preferred embodiments of the present invention also contemplates either first filling the resting tanks with natural mineral thermal spring water or thermal mineral spring water and then adding/filling the resting tanks with the coffee beans with the mucilage or alternatively first filling the resting tanks with the coffee beans with the mucilage and then filling the resting tanks with the natural mineral thermal spring water or thermal mineral spring water, in sufficient quantities to submerged the coffee beans with mucilage. However, in each instance the temperature of the natural mineral thermal spring water or thermal mineral spring water is controlled, as set forth in greater detail herein.

Thereafter, the coffee beans with the mucilage layer are left to rest in a submerged state within the natural mineral thermal spring water or thermal mineral spring water for a minimum of 8 hours and preferably for a resting time of 8 to 12 hours. As set forth above, this is a significantly less resting time than presently utilized in a dry resting/fermentation procedure commonly known. Further, when originated from its natural source, the natural mineral thermal spring water or thermal mineral spring water is considered to be at a temperature within the hyperthermal range, generally at 149° F. to 158° F. However, before submerging the coffee beans with the mucilage layer in the natural mineral thermal spring water or thermal mineral spring water, the temperature thereof is allowed to drop to a preferred temperature range of 113° F. As such, the thermal spring water is allowed to cool from the hyperthermal temperature range to a mesothermal temperature range of about 113° F.

In addition, during the resting time of between 8 to 12 hours the natural mineral thermal spring water or thermal mineral spring water is allowed to gradually and naturally cool to what may be considered a hypothermal temperature range below 113° F. Moreover, the addition of natural mineral thermal spring water or thermal mineral spring water within the predetermined temperature ranges results in an enhancement of the enzymatic process of the mesocarp or mucilage, which in turn results in obtaining the coffee beans without the mucilage layer in an extremely clean condition, wherein all pollutants and objectionable flavor causing ingredients are removed. Upon conclusion of the resting period of from 8 to 12 hours, the coffee beans without the mucilage layer are removed from the resting facility and the process is continued.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A method for the intermediate fermentation processing of coffee beans with the mucilage layer, the method comprising:
delivering the coffee beans with the mucilage layer to a resting facility subsequent to a first-time pulping,
combining in a resting facility a predetermined capacity of the coffee beans with the mucilage layer with water of predetermined content,
submerging the coffee beans with the mucilage layer in the water of predetermined content,
removing the mucilage layer from the coffee beans comprising maintaining the coffee beans with the mucilage layer in the resting facility in a submerged state for a predetermined time,
controlling the temperature of the water of predetermined content within a predetermined temperature range during the submerged state,
draining the water from the resting facility and the coffee beans upon conclusion of the predetermined time, and
removing the drained coffee beans without the mucilage layer from the resting facility and delivering the coffee beans without the mucilage layer to additional processing facilities.

2. The method as recited in claim 1 comprising defining the content of the natural water as thermal mineral spring water.

3. The method as recited in claim 1 comprising submerging the coffee beans with the mucilage layer in the water of predetermined content and controlling the predetermined temperature range to be within a mesothermal temperature range.

4. The method as recited in claim 3 comprising defining the mesothermal temperature range as being generally about 113° F.

5. The method as recited in claim 3 comprising defining the water of predetermined content as natural thermal mineral spring water.

6. The method as recited in claim 3 comprising initially acquiring the water of predetermined content having a temperature within the hyperthermal temperature range.

7. The method as recited in claim 6 comprising defining the hyperthermal temperature range as being between generally about 149° F. to 158° F.

8. The method as recited in claim 6 comprising allowing the water of predetermined content to cool to the mesothermal temperature range prior to submerging the coffee beans with the mucilage layer therein.

9. The method as recited in claim 3 comprising allowing the water of predetermined content to cool to a hypothermal temperature range during the predetermined time of resting concurrent to the coffee beans with the mucilage layer being submerged.

10. The method as recited in claim 1 comprising maintaining the coffee beans with the mucilage layer in a submerged state in the resting facility for the predetermined time of at least 8 hours.

11. The method as recited in claim 10 comprising maintaining the coffee beans with the mucilage layer in a submerged state in the resting facility for the predetermined time of between 8 and 12 hours.

12. The method as recited in claim 10 comprising defining the water of predetermined content as thermal spring water.

13. The method as recited in claim 12 comprising submerging the coffee beans with the mucilage layer in the natural thermal mineral spring water having the predetermined temperature range within a mesothermal temperature range.

14. The method as recited in claim 13 comprising defining the mesothermal temperature range as being generally about 113° F.

15. The method as recited in claim 13 comprising allowing the natural thermal mineral spring water to gradually cool to a temperature below 113° F. during the predetermined time of resting concurrent to the coffee beans with the mucilage layer being submerged in the natural thermal mineral spring water.

16. The method as recited in claim 1 further comprising delivering the coffee beans to additional processing facilities including a wash and drain facility; washing the coffee beans with water.

17. The method as recited in claim 1 comprising filling the resting facility with the coffee beans with the mucilage layer concurrently to continuously draining the resting facility with the water.

18. A method for the intermediate fermentation processing of coffee beans with a mucilage layer, the method comprising:
delivering the coffee beans with the mucilage layer to a resting facility subsequent to a first pulping procedure being performed thereon,
combining in the resting facility a predetermined capacity of the coffee beans with the mucilage layer with thermal spring water in sufficient quantity to submerge the coffee beans with the mucilage layer,
submerging the coffee beans with the mucilage layer in the thermal spring water having an at least minimal predetermined temperature,
further controlling the temperature of the thermal spring water within a predetermined temperature range during the submerging of the coffee beans with the mucilage layer,
removing the mucilage layer from the coffee beans comprising maintaining the coffee beans with the mucilage layer in the resting facility in a submerged state for a predetermined resting time,
draining the thermal spring water from the resting facility upon conclusion of the predetermined resting time, and
removing the drained coffee beans from the resting facility and delivering the coffee beans to additional processing facilities.

19. The method as recited in claim 18 comprising defining the minimum predetermined temperature range of the thermal spring water being combined with the coffee beans with the mucilage layer as generally about 113° F.

20. The method as recited in claim 19 comprising allowing the thermal spring water to gradually cool within the resting facility during the predetermined resting time concurrent to the coffee beans with the mucilage layer being submerged.

21. The method as recited in claim 20 comprising maintaining the coffee beans with the mucilage layer in the submerged state in the resting facility for the predetermined time of between 8 hours and 12 hours.

22. The method as recited in claim 18 comprising defining the thermal spring water as natural thermal spring water or thermal mineral spring water.
